(19) United States
(12) Patent Application Publication
(10) Pub. No.: US 2024/0389145 A1
(43) Pub. Date: Nov. 21, 2024

(54) MULTI-CHANNEL OPERATION IN WIRELESS NETWORKS

(71) Applicant: NEWRACOM, Inc., Irvine, CA (US)

(72) Inventors: Heejung YU, Daejeon (KR); Joonsoo LEE, Seoul (KR); Si-Chan NOH, Seoul (KR)

(73) Assignee: NEWRACOM, Inc., Irvine, CA (US)

(21) Appl. No.: 18/665,434

(22) Filed: May 15, 2024

Related U.S. Application Data
(60) Provisional application No. 63/503,063, filed on May 18, 2023.

(51) Int. Cl. H04W 74/0816; H04L 5/00; H04W 74/08; H04W 84/12

(52) U.S. Cl. CPC H04W 74/0816; H04L 5/0053; H04W 74/0866; H04W 84/12

(57) ABSTRACT

Disclosed herein is a method performed by a first wireless device in a wireless network to perform multi-channel operations. The method includes transmitting a cross-channel request-to-send (RTS) frame to a second wireless device in a first channel, receiving a cross-channel clear-to-send (CTS) frame from the second wireless device in the first channel, responsive to receiving the cross-channel CTS frame in the first channel, transmitting a data frame to the second wireless device in a second channel, and receiving a cross-channel acknowledgement (ACK) frame that acknowledges the data frame from the second wireless device in the first channel.

### CROSS-REFERENCE TO RELATED APPLICATION

This application claims the benefit of U.S. Provisional Application No. 63/503,063, filed May 18, 2023, titled, “Multi-channel operation with mmWave and Sub-7 GHz bands for beyond IEEE 802.11be networks,” which is hereby incorporated by reference.

### TECHNICAL FIELD

The present disclosure generally relates to wireless communications, and more specifically, relates to performing multi-channel operations in a wireless network.

### BACKGROUND

Institute of Electrical and Electronics Engineers (IEEE) 802.11 is a set of physical and Media Access Control (MAC) specifications for implementing Wireless Local Area Network (WLAN) communications. These specifications provide the basis for wireless network products using the Wi-Fi brand managed and defined by the Wi-Fi Alliance. The specifications define the use of the 2.400-2.500 Gigahertz (GHz) as well as the 4.915-5.825 GHz bands. These spectrum bands are commonly referred to as the 2.4 GHz and 5 GHz bands. Each spectrum is subdivided into channels with a center frequency and bandwidth. The 2.4 GHz band is divided into 14 channels spaced 5 Megahertz (MHz) apart, though some countries regulate the availability of these channels. The 5 GHz band is more heavily regulated than the 2.4 GHz band and the spacing of channels varies across the spectrum with a minimum of a 5 MHz spacing dependent on the regulations of the respective country or territory.

WLAN devices are currently being deployed in diverse environments. These environments are characterized by the existence of many Access Points (APs) and non-AP stations (STAs) in geographically limited areas. Increased interference from neighboring devices gives rise to performance degradation. Additionally, WLAN devices are increasingly required to support a variety of applications such as video, cloud access, and offloading. Video traffic, in particular, is expected to be the dominant type of traffic in WLAN deployments. With the real-time requirements of some of these applications, WLAN users demand improved performance.

Due to the scarcity of available bandwidth in sub-7 Gigahertz (GHz) frequency bands such as the 900 MHZ, 2.4 GHz, 5 GHZ, and 6 GHz bands, millimeter wave (mmWave) bands (above 7 GHz frequency bands (e.g., serval tens of GHz)) are being considered as candidate frequency bands for use in future wireless networking standards (e.g., beyond IEEE 802.11be standards) because wider bandwidth can be secured in mmWave bands. The wider bandwidth may be particularly beneficial for transmitting high-volume traffic (e.g., traffic for virtual reality and other high-resolution multimedia contents).

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example wireless local area network (WLAN) with a basic service set (BSS) that includes a plurality of wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates Inter-Frame Space (IFS) relationships, in accordance with some embodiments of the present disclosure.

FIG. 5 illustrates a Carrier Sense Multiple Access/Collision Avoidance (CSMA/CA) based frame transmission procedure, in accordance with some embodiments of the present disclosure.

FIG. 6 shows a table comparing various iterations of Institute of Electrical and Electronics Engineers (IEEE) 802.11 standard, in accordance with some embodiments of the present disclosure.

FIG. 7 shows a table, which describes fields of an Extreme High Throughput (EHT) frame format, in accordance with some embodiments of the present disclosure.

FIG. 8 is a diagram showing a frame exchange sequence for performing multi-channel operations in mmWave and sub-7 GHz channels using RTS-mm, CTS-mm, T-CTS-mm and ACK-mm control frames, according to some embodiments.

FIG. 9 is a diagram showing a frame exchange sequence for performing multi-channel operations in mmWave and sub-7 GHz channels using trigger-mm and ACK-mm control frames, according to some embodiments.

FIG. 10 is a diagram showing a frame exchange sequence for performing multi-channel operations in mmWave and sub-7 GHz channels using LLT-RTS-mm, LLT-CTS-mm and STOP-mm control frames, according to some embodiments.

FIG. 11 is a flow diagram showing another method for performing multi-channel operations, according to some embodiments, according to some embodiments.

FIG. 12 is a flow diagram showing another method for performing multi-channel operations, according to some embodiments.

FIG. 13 is a flow diagram showing another method for performing multi-channel operations, according to some embodiments.

FIG. 14 is a flow diagram showing another method for performing multi-channel operations, according to some embodiments.

FIG. 15 is a flow diagram showing another method for performing multi-channel operations, according to some embodiments.

FIG. 16 is a flow diagram showing another method for performing multi-channel operations, according to some embodiments.

FIG. 17 is a flow diagram showing another method for performing multi-channel operations, according to some embodiments.

### DETAILED DESCRIPTION

One aspect of the present disclosure generally relates to wireless communications, and more specifically, relates to performing multi-channel operations in a wireless network.

As mentioned above, the wider bandwidth available in millimeter wave (mmWave) frequency bands may be particularly beneficial for transmitting high-volume traffic (e.g., traffic for virtual reality and other high-resolution multimedia contents). However, the wider bandwidth of mmWave bands may be inefficient for transmitting control frames that only have a small number of bits such as request-to-send (RTS) frames, clear-too-send (CTS) frames, and acknowledgement (ACK) frames because the bandwidth may be underutilized. To mitigate such inefficient spectral utilization of mm Wave channels, the present disclosure proposes multi-channel operations that use a mmWave channel and a sub-7 Gigahertz (GHz) channel for data frame transmission and control frame transmission, respectively, which allows for more efficient usage of the mm Wave channel.

To more efficiently use the wider bandwidth available in mmWave channels, embodiments transmit control frames in a sub-7 GHz channel and transmit data frames in a mmWave channel. For example, control frames such as RTS frames, CTS frames, ACK frames, and trigger frames (e.g., for soliciting uplink transmissions) may be transmitted in a sub-7 GHZ channel, while data frames may be transmitted in a mmWave channel that has wider bandwidth (and thus higher data rate). Also, embodiments may use several new control frames, as will be further described herein, to more efficiently control the usage of the mmWave channel (e.g., to reduce time spacing between consecutive data frames).

More generally, with embodiments, control frames may be transmitted in a first channel and data frames may be transmitted in a second channel, where the second channel is in a higher frequency band than the first channel. According to some embodiments, a first wireless device in a wireless network transmits a cross-channel RTS frame to a second wireless device in a first channel. As used herein, a “cross-channel” frame may refer to a frame that is transmitted in one channel but controls operations in another channel. Responsive to receiving the cross-channel RTS frame in the first channel, a second wireless device in the wireless network may transmit a cross-channel CTS frame to the first wireless device in the first channel. Responsive to receiving the cross-channel CTS frame in the first channel, the first wireless device may transmit a data frame to the second wireless device in a second channel. Responsive to receiving the data frame in the second channel, the second wireless device may transmit a cross-channel ACK frame that acknowledges the data frame to the first wireless device in the first channel. In an embodiment, the first channel is a sub-7 GHz channel and the second channel is a mmWave channel. By transmitting control frames, which are relatively small in size, in the first channel and transmitting data frames, which are (typically) relatively large in size, in the second channel (e.g., which has wider bandwidth), the spectrum is utilized more efficiently.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

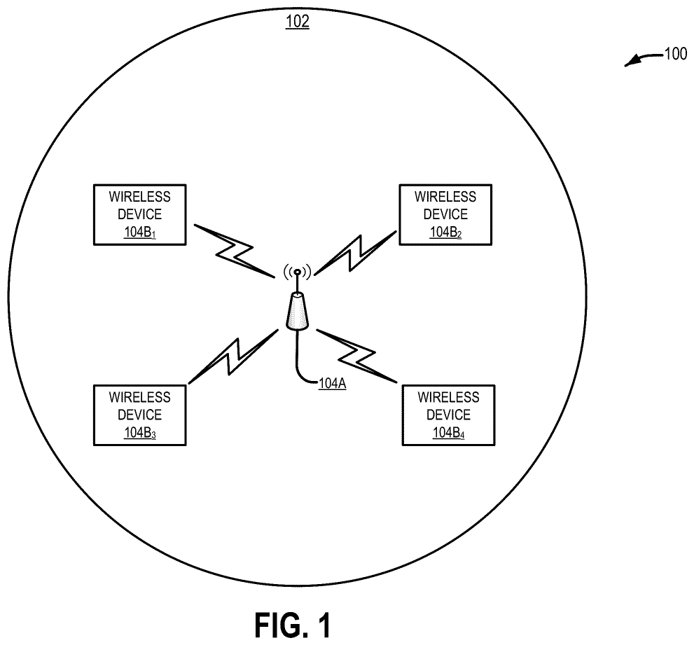

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs. Although shown with four non-AP STAs (e.g., the wireless devices 104B₁-104B₄), the WLAN 100 may include any number of non-AP STAs (e.g., one or more wireless devices 104B).

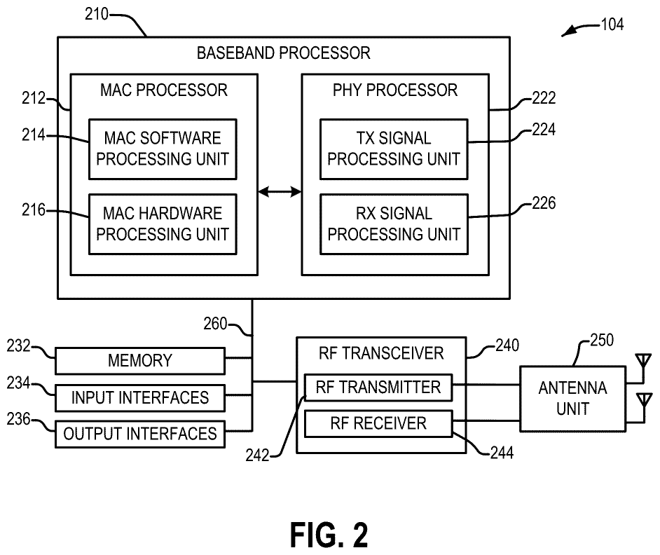

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

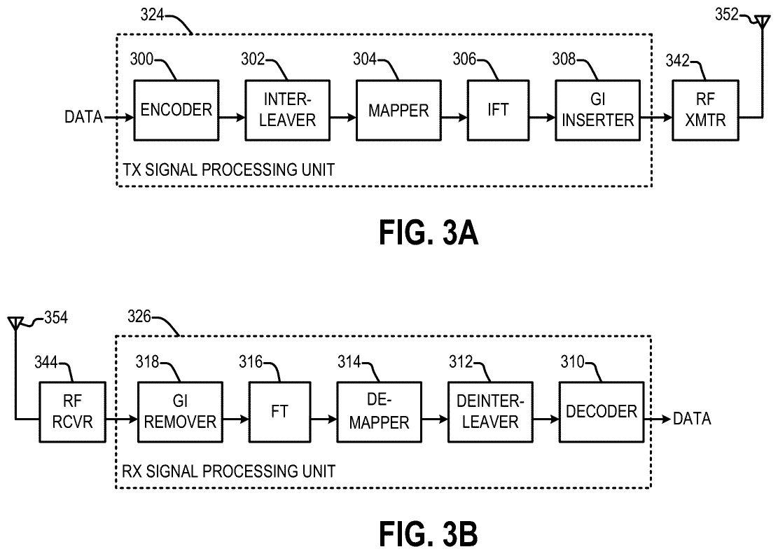

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of Os or Is. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

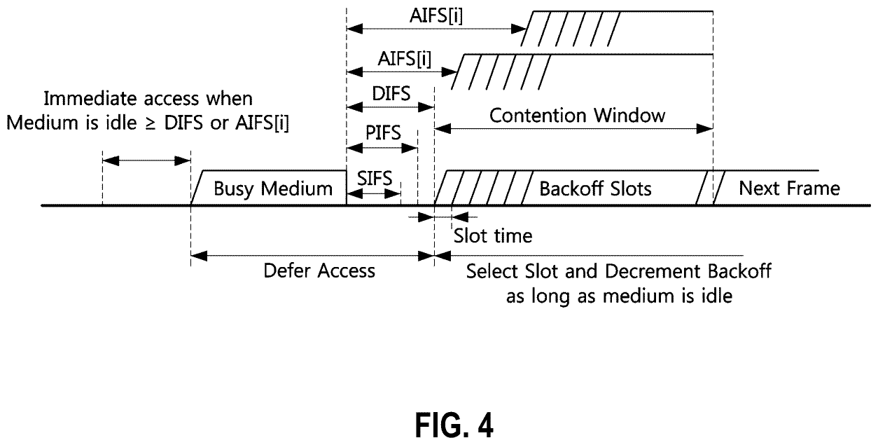

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS [i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS [AC]) has elapsed. When transmitted by the QOS STA, any of the data frame, the management frame, and the control frame, which is not the response frame, may use the AIFS [AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

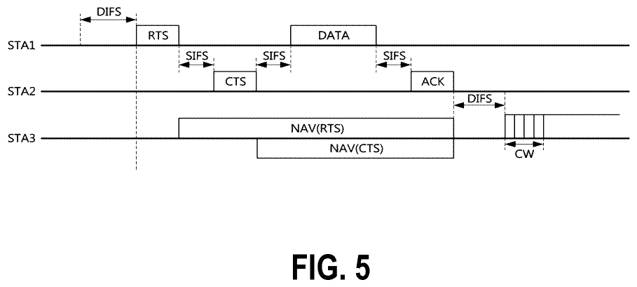

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

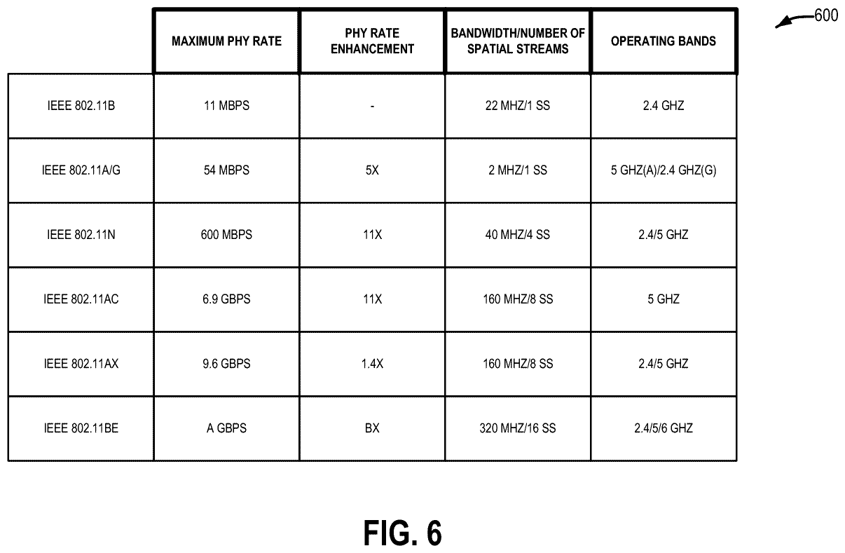

With clear demand for higher peak throughput/capacity in a WLAN, a new working group has been assembled to generate an amendment to IEEE 802.11. This amendment is called IEEE 802.11be (i.e., Extreme High Throughput (EHT)) and was created to support an increase to the peak PHY rate of a corresponding WLAN. Considering IEEE 802.11b through 802.11ac, the peak PHY rate has been increased by 5× to 11× as shown in FIG. 6, which presents a table 600 comparing various iterations of IEEE 802.11. In case of IEEE 802.11ax, the 802.11ax working group focused on improving efficiency, not peak PHY rate in dense environments. The maximum PHY rate (A Gbps) and PHY rate enhancement (Bx) for IEEE 802.11be could rely on the highest MCS (e.g., 4,096 QAM and its code rate).

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHZ) is being considered for unlicensed use. This would allow APs and STAs to become tri-band devices. Larger than 160 MHz data transmissions (e.g., 320 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

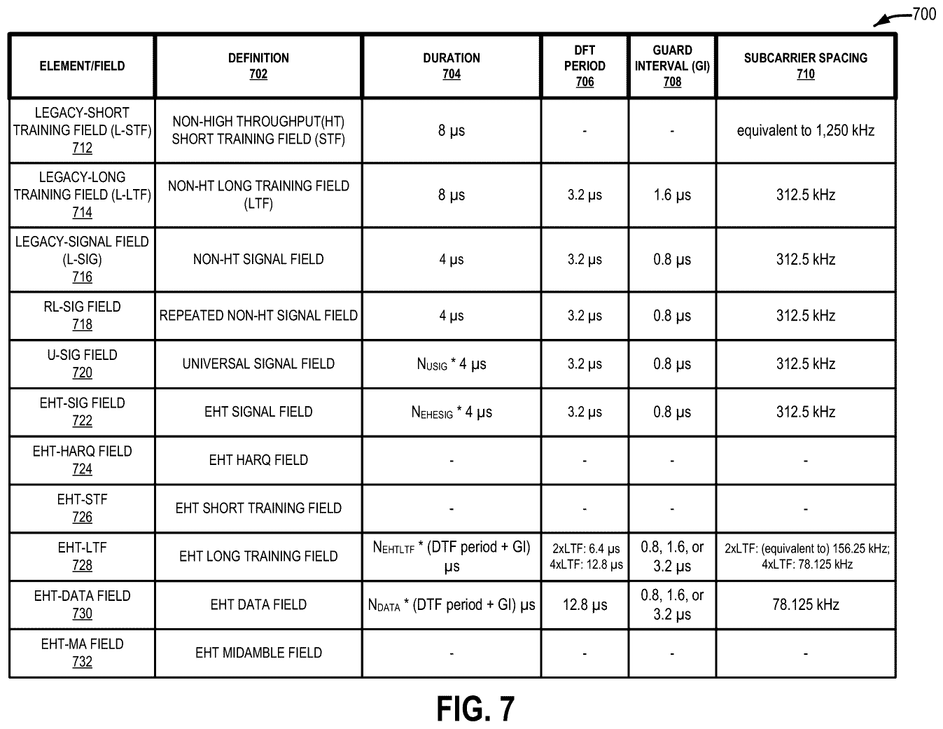

In some embodiments, a transmitting STA generates a PPDU frame and transmits it to a receiving STA. The receiving STA receives, detects, and processes the PPDU. The PPDU can be an EHT PPDU that includes a legacy part (e.g., a legacy short training field (L-STF), a legacy long training field (L-LTF), and a legacy signal (L-SIG) field), an EHT signal A field (EHT-SIG-A), an EHT signal B field (EHT-SIG-B), an EHT hybrid automatic repeat request field (EHT-HARQ), an EHT short training field (EHT-STF), an EHT long training field (EHT-LTF), and an EHT-DATA field. FIG. 7 includes a table 700, which describes fields of an EHT frame format. In particular, table 700 describes various fields that may be within the PHY preamble, data field, and midamble of an EHT frame format. For example, table 700 includes definitions 702, durations 704, Discrete Fourier transform (DFTs) periods 706, guard intervals (GIs) 708, and subcarrier spacings 710 for one or more of a legacy short training field (L-STF) 712, legacy long training field (L-LTF) 714, legacy signal field (L-SIG) 716, repeated L-SIG (RL-SIG) 718, universal signal field (U-SIG) 720, EHT signal field (EHT-SIG) 722, EHT hybrid automatic repeat request field (EHT-HARQ) 724, EHT short training field (EHT-STF) 726, EHT long training field (EHT-LTF) 728, EHT data field 730, and EHT midamble field (EHT-MA) 732.

The distributed nature of a channel access network, such as in IEEE 802.11 wireless networks, makes carrier sensing mechanisms important for collision free operation. The physical carrier sensing mechanism of one STA is responsible for detecting the transmissions of other STAs. However, it may be impossible to detect every single case in some circumstances. For example, one STA which may be a long distance away from another STA may see the medium as idle and begin transmitting a frame while the other STA is also transmitting. To overcome this hidden node, a network allocation vector (NAV) may be used. However, as wireless networks evolve to include simultaneous transmission/reception to/from multiple users within a single basic service set (BSS), such as uplink (UL)/downlink (DL) multi-user (MU) transmissions in a cascading manner, a mechanism may be needed to allow for such a situation. As used herein, a multi-user (MU) transmission refers to cases that multiple frames are transmitted to or from multiple STAs simultaneously using different resources. Examples of different resources are different frequency resources in OFDMA transmissions and different spatial streams in MU-MIMO transmissions. Therefore, DL-OFDMA, DL-MU-MIMO, UL-OFDMA, and UL-MU-MIMO are examples of MU transmissions.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

To improve WLAN systems, AP cooperation has been discussed as a possible technology to be adopted in IEEE 802.11be, where there is high level classification depending on various AP cooperation schemes. For example, there is a first type of cooperation scheme in which data for a user is sent from a single AP (sometimes referred to as “coordinated”) and there is a second type of cooperation scheme in which data for a user is sent from multiple APs (sometimes referred to as “joint”).

For the coordinated scheme, multiple APs are 1) transmitting on the same frequency resource based on coordination and forming spatial nulls to allow for simultaneous transmission from multiple APs or 2) transmitting on orthogonal frequency resources by coordinating and splitting the spectrum to use the spectrum more efficiently. For the joint scheme, multiple APs are transmitting jointly to a given user.

In mm Wave channels, wider bandwidth can be secured and high data rate transmission within a short distance/range is possible. With the wider bandwidth available in mmWave channels, a large number of data bits can be delivered in a short period of time. Control frames are used to control operations in a wireless network. Control frames such as RTS frames, CTS frames, and ACK frames consist of a small number of bits. Also, control frames include preambles that include a short training field, a long training field, and signal field(s). The time duration of control frames may not be negligibly small. As a result, the overhead of control frames can introduce inefficiency in the spectral utilization of mmWave channels. To improve the efficiency of wide bandwidth utilization, embodiments perform multi-channel operations in mmWave and sub-7 GHz channels. For example, embodiments may transmit control frames in a sub-7 GHz channel and transmit data frames in a mmWave channel. To distinguish from the legacy control frames in sub-7 GHz channels and to define new transmission protocols for multi-channel operations, several new control frames (e.g., cross-channel control frames) are introduced herein.

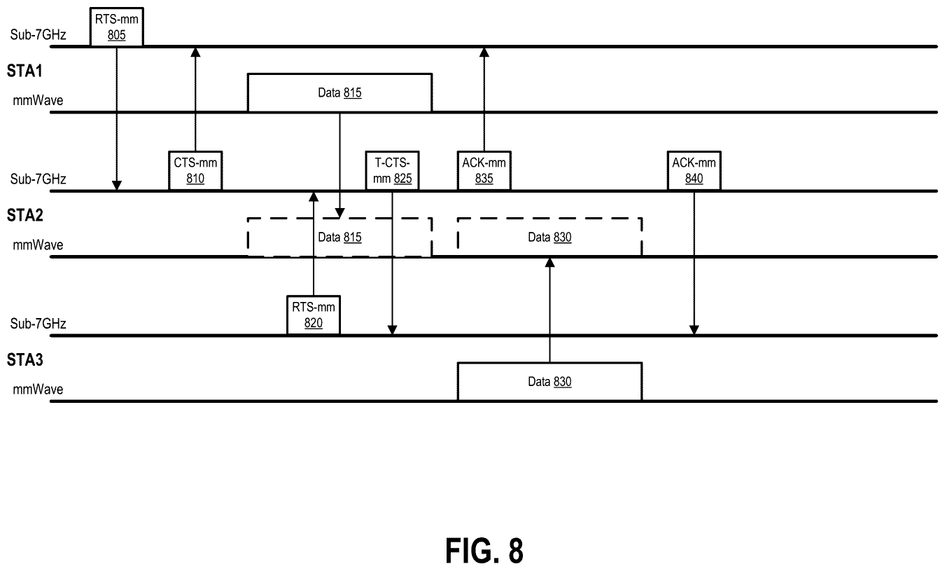

FIG. 8 is a diagram showing a frame exchange sequence for performing multi-channel operations in mmWave and sub-7 GHz channels using RTS-mm, CTS-mm, T-CTS-mm and ACK-mm control frames, according to some embodiments.

In the frame exchange sequence, STA1, STA2, and STA3 may perform multi-channel operations by transmitting and/or receiving frames in a sub-7 GHz channel and a mmWave channel. As shown in the diagram, STA1 may transmit a RTS-mm frame 805 to STA2 in the sub-7 GHz channel. The RTS-mm frame 805 may be a RTS frame for a transmission opportunity in the mmWave channel. Responsive to receiving the RTS-mm frame 805 in the sub-7 GHz channel, STA2 may transmit a CTS-mm frame 810 to STA1 in the sub-7 GHZ channel. The CTS-mm frame 810 may be a CTS frame for a transmission opportunity in the mmWave channel. Responsive to receiving the CTS-mm frame 810 in the sub-7 GHz channel, STA1 may transmit a data frame 815 to STA2 in the mmWave channel.

In an embodiment, while STA1 is transmitting data frame 815 to STA2 and STA2 is receiving data frame 815 from STA1 in the mmWave channel, STA3 may transmit a RTS-mm frame 820 to STA2 in the sub-7 GHz channel to acquire a transmission opportunity in the mmWave channel. STA3 may not be able to sense the signal in the mmWave channel due to its location. Responsive to receiving RTS-mm frame 820 in the sub-7 GHz channel, STA2 may transmit a target CTS-mm (T-CTS-mm) frame 825 to STA3 in the sub-7 GHz channel (since the sub-7 Ghz channel is idle at this time). T-CTS-mm frame 825 may indicate a time at which STA3 is allowed to transmit data in the mmWave channel. In an embodiment, T-CTS-mm frame 825 indicates the time at which STA3 is allowed to transmit data as a time delay (e.g., as a length of time after transmission of the T-CTS-mm frame 825). Responsive to receiving the T-CTS-mm frame 825 in the sub-7 GHz channel, STA3 may transmit a data frame 830 to STA2 at the time indicated by the T-CTS-mm frame 825. The time indicated by the T-CTS-mm frame 825 may be shortly after STA2 finishes receiving data frame 815 from STA1 such that STA3 can transmit data frame 830 immediately after STA2 finishes receiving data frame 815, thereby minimizing the time interval between data frame transmissions.

If STA2 successfully receives data frame 815 from STA1 in the mmWave channel, STA2 may transmit an ACK-mm frame 835 to STA1 in the sub-7 GHz channel (e.g., while STA2 receives data frame 830 from STA3 in the mmWave channel). ACK-mm frame 835 may acknowledge data frame 815 received in the mmWave channel. Similarly, if STA2 successfully receives data frame 830 from STA3 in the mmWave channel, STA2 may transmit an ACK-mm frame 840 to STA3 in the sub-7 GHz channel. ACK-mm frame 840 may acknowledge data frame 830 received in the mmWave channel.

By using such frame exchange sequence shown in the diagram, the mm Wave channel can be used in an efficient manner, without incurring the overhead of control frames.

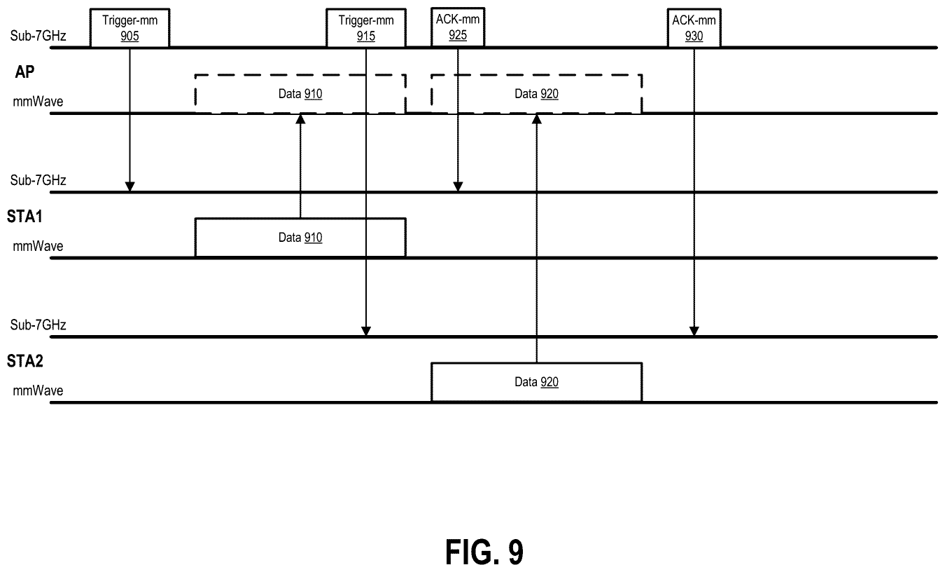

FIG. 9 is a diagram showing a frame exchange sequence for performing multi-channel operations in mmWave and sub-7 GHz channels using trigger-mm and ACK-mm control frames, according to some embodiments.

In the frame exchange sequence, AP, STA1, and STA2 may perform multi-channel operations by transmitting and/or receiving frames in a sub-7 GHz channel and a mmWave channel. As shown in the diagram, AP may transmit a trigger-mm frame 905 in the sub-7 GHZ channel to solicit an uplink data frame transmission from STAs (e.g., STA1) to AP in the mmWave channel. Responsive to receiving the trigger-mm frame 905 in the sub-7 GHZ channel, STA1 may transmit a data frame 910 to AP in the mmWave channel (as part of the uplink transmission solicited by trigger-mm frame 905).

Since data frame 910 is transmitted in the mmWave channel, AP may transmit another trigger-mm frame 915 in the sub-7 GHz channel while AP receives data frame 910 in the mmWave channel.

Responsive to receiving trigger-mm frame 915 in the sub-7 GHz channel, STA2 may transmit a data frame 920 to AP in the mmWave channel (as part of the uplink transmission solicited by trigger-mm frame 915).

If AP successfully receives data frame 910 from STA1 in the mmWave channel, AP may transmit an ACK-mm frame 925 to STA1 in the sub-7 GHz channel (e.g., while AP receives data frame 920 from STA2 in the mmWave channel). ACK-mm frame 925 may acknowledge data frame 910, which was received in the mmWave channel. Similarly, if AP successfully receives data frame 920 from STA2 in the mmWave channel, AP may transmit an ACK-mm frame 930 to STA2 in the sub-7 GHz channel. ACK-mm frame 930 may acknowledge data frame 920, which was received in the mm Wave channel.

Using such frame exchange sequence, AP may solicit uplink data frames from STA1 and STA2 with minimal control overhead in the mm Wave channel. Also, by overlapping the trigger-mm frame 915 transmission and data frame 910 transmission, data frames from STA1 and STA2 can be transmitted to AP with minimal time interval between data frame transmissions.

While the diagram shows an example of a single user (SU) uplink transmission, it should be appreciated that the trigger-mm frames 915 can be used to solicit a multi-user (MU) uplink transmission (e.g., a MU-MIMO or UL OFDMA transmission) from multiple STAs.

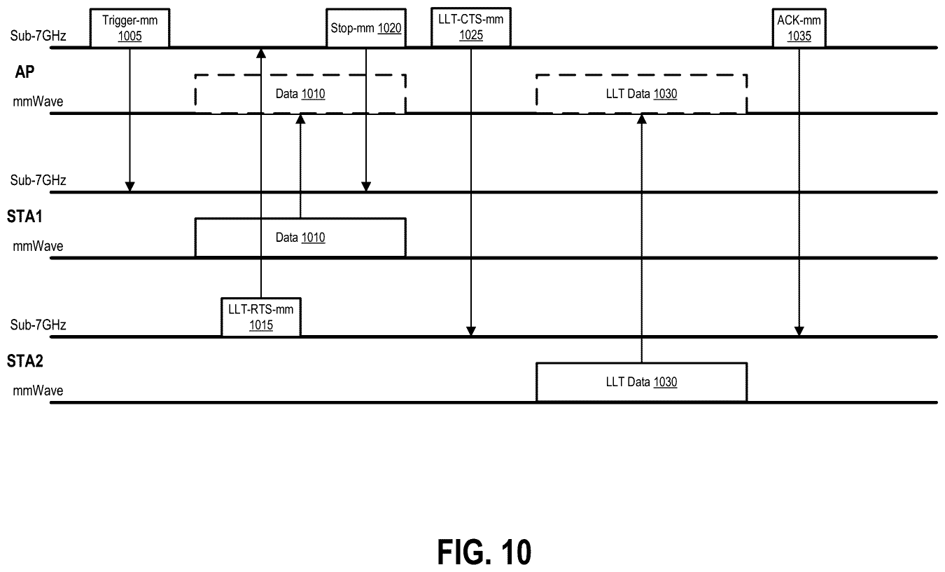

FIG. 10 is a diagram showing a frame exchange sequence for performing multi-channel operations in mmWave and sub-7 GHz channels using LLT-RTS-mm, LLT-CTS-mm and stop-mm control frames, according to some embodiments.

In the frame exchange sequence, AP, STA1, and STA2 may perform multi-channel operations by transmitting and/or receiving frames in a sub-7 GHz channel and a mmWave channel. As shown in the diagram, AP may transmit a trigger-mm frame 1005 in the sub-7 GHZ channel to solicit an uplink data frame transmission from STAs (e.g., STA1) to AP in the mmWave channel. Responsive to receiving the trigger-mm frame 1005 in the sub-7 GHZ channel, STA1 may transmit a data frame 1010 to AP in the mmWave channel (as part of the uplink transmission solicited by trigger-mm frame 1005).

While STA1 is transmitting data frame 1010 to AP in the mmWave channel, STA2 may have low latency data (latency sensitive data) to transmit to AP. Thus, STA2 may transmit a LLT-RTS-mm frame 1015 to AP in the sub-7 GHz channel. The LLT-RTS-mm frame 1015 may be a RTS frame for a low latency transmission opportunity in the mm Wave channel.

Responsive to receiving the LLT-RTS-mm frame 1015 in the sub-7 GHz channel, AP may transmit a stop-mm frame 1020 to STA1 in the sub-7 GHz channel to cause STA1 to stop transmission of data frame 1010 in the mmWave channel. Since stop-mm frame 1020 is transmitted in the sub-7 GHz channel, AP may transmit it to STA1 while receiving data frame 1010 from STA1 in the mmWave channel.

Responsive to receiving stop-mm frame 1020 in the sub-7 GHz channel, STA1 may stop transmission of data frame 1010 to AP in the mmWave channel.

After transmitting stop-mm frame 1020 to STA1 in the sub-7 GHz channel, AP may transmit a LLT-CTS-mm frame 1025 to STA2 in the sub-7 GHz channel. The LLT-CTS-mm frame 1015 may be a CTS frame for a low latency transmission opportunity in the mm Wave channel.

Responsive to receiving LLT-CTS-mm frame 1015 in the sub-7 GHZ channel, STA2 may transmit a LLT (low latency transmission) data frame 1030 that includes low latency data to AP in the mmWave channel. Low latency data may be data that needs to be transmitted with low latency. If AP successfully receives LLT data frame 1030 from STA2 in the mmWave channel, AP may transmit an ACK-mm frame 1035 to STA2 in the sub-7 GHz channel. ACK-mm frame 1035 may acknowledge data frame 1030, which was received in the mmWave channel.

Using such frame exchange sequence, AP may stop data frame transmission of STA1 to allow STA2 to transmit low latency (latency sensitive) data.

With the frame exchange sequences shown in FIGS. 8, 9, and 10, spectrum utilization of the mm Wave channel is improved by using new cross-channel control frames transmitted in the sub-7 GHz channel that can control the mmWave channel operations.

Since the new cross-channel control frames (e.g., RTS-mm frame, CTS-mm frame, T-CTS-mm frame, ACK-mm frame, trigger-mm frame, LLT-RTS-mm frame, LLT-CTS-mm frame, and stop-mm frame) are transmitted in the sub-7 GHz channel, protection from legacy wireless devices may be needed. Several approaches to protecting the cross-channel control frames are described below.

In an embodiment, before transmitting the first cross-channel control frame in the sub-7 GHz channel, a CTS-to-self frame is transmitted in the sub-7 GHz channel to set a network allocation vector (NAV) for the duration of the frame exchange sequence. For example, in the frame exchange sequence shown in FIG. 8, STA1 may transmit a CTS-to-self frame before transmitting RTS-mm frame 805 to set a NAV from the end of the CTS-to-self frame to the end of ACK-mm frame 835. As another example, in the frame exchange sequence shown in FIG. 9, AP may transmit a CTS-to-self frame before transmitting trigger-mm frame 905 to set a NAV from the end of the CTS-to-self frame to the end of ACK-mm frame 925. In the case of low latency transmission example shown in FIG. 10, AP cannot accurately predict the total transmission opportunity duration at the time it transmits trigger-mm frame 1005 because it cannot anticipate that STA2 will transmit LLT-RTS-mm frame 1015. In this case, AP may transmit a CTS-to-self frame immediately before transmitting trigger-mm frame 1005 to set a NAV from the end of the CTS-to-self frame to the end of an expected ACK-mm frame. AP may then extend the protection time (i.e., extend the NAV) after receiving LLT-RTS-mm frame 1015 from STA2. AP may achieve this by transmitting an additional CTS-to-self frame immediately before transmitting LLT-CTS-mm frame 1025 to set a NAV from the end of the additional CTS-to-self frame to the end of an expected ACK-mm frame 1035. In an embodiment, such CTS-to-self frame may play the role of a LLT-CTS-mm frame for STA2. That is, STA2 may interpret the CTS-to-self frame as a LLT-CTS-mm frame, while other STAs, including legacy wireless devices, may interpret the CTS-to-self frame normally (as a legacy CTS-to-self frame). In an embodiment, LLT-CTS-mm frame 1025 is used to set/extend a NAV. For example, in the frame exchange sequence shown in FIG. 10, AP may transmit a CTS-to-self frame before transmitting trigger-mm frame 1005 to set a NAV from the end of the CTS-to-self frame to the end of an expected ACK-mm frame. However, in this example frame exchange sequence, there is no ACK-mm frame (corresponding to data frame 1010) because the stop-mm frame 1020 stops the transmission of data frame 1010. That is, the expected ACK-mm frame is not transmitted because the transmission of data frame 1010 is stopped to allow STA2 to transmit low latency data. In this case, LLT-CTS-mm frame 1025 (or an additional CTS-to-self frame) may be used to set/extend a NAV from the end of LLT-CTS-mm frame 1025 until the end of ACK-mm frame 1035.

In an embodiment, the legacy formats of the control frames are modified and used as the new cross-channel control frames to control operations in the mm Wave channel. Then, the new cross-channel control frames (e.g., RTS-mm frame, CTS-mm frame, trigger-mm frame, and ACK-mm frame) are regarded by legacy wireless devices as legacy control frames, which can set the NAV for the intended duration. At the same time, wireless devices supporting multi-channel operations (and which understand the format of cross-channel control frames) may regard such frames as cross-channel control frames for controlling mm Wave channel operations.

Example embodiments of multi-channel operations have been described in the context where operations are performed in a sub-7 GHz channel and a mm Wave channel. It should be appreciated that such channels are provided by way of example only and that the multi-channel operations disclosed herein can be performed in other channels (e.g., any two channels that have different bandwidths).

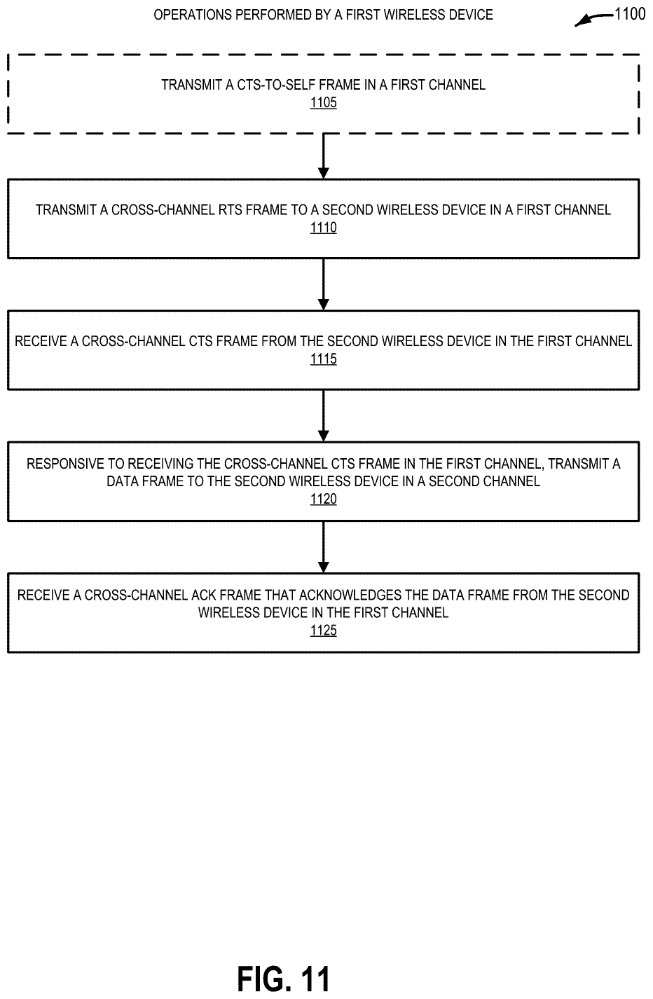

Turning now to FIG. 11, a method 1100 will be described for performing multi-channel operations, in accordance with an example embodiment. The method 1100 may be performed by one or more devices described herein. For example, the method 1100 may be performed by a first wireless device in a wireless network (e.g., STA1 shown in FIG. 1).

Additionally, although shown in a particular order, in some embodiments the operations of the method 1100 (and the other methods shown in the other figures) may be performed in a different order. For example, although the operations of the method 1100 are shown in a sequential order, some of the operations may be performed in partially or entirely overlapping time periods.

In an embodiment, at operation 1105, the first wireless device transmits a CTS-to-self frame in a first channel (e.g., to set a NAV from the end of the CTS-to-self frame to the end of an upcoming/expected cross-channel ACK frame transmission (which is received by the first wireless device at operation 1125)).

At operation 1110, the first wireless device transmits a cross-channel RTS frame (e.g., RTS-mm frame) to a second wireless device in the first channel. As previously mentioned, a “cross-channel” frame may be a frame that is transmitted in one channel but controls operations in another channel.

At operation 1115, the first wireless device receives a cross-channel CTS frame (e.g., CTS-mm frame) from the second wireless device in the first channel.

At operation 1120, responsive to receiving the cross-channel CTS frame in the first channel, the first wireless device transmits a data frame to the second wireless device in a second channel.

At operation 1125, the first wireless device receives a cross-channel ACK frame (e.g., ACK-mm frame) that acknowledges the data frame from the second wireless device in the first channel.

In an embodiment, the first channel is a sub-7 GHz channel and the second channel is a mmWave channel.

In an embodiment, the cross-channel RTS frame, the cross-channel CTS frame, and the cross-channel ACK frame are treated by legacy wireless devices as legacy control frames for the first channel and treated by non-legacy wireless devices as cross-channel control frames for the second channel.

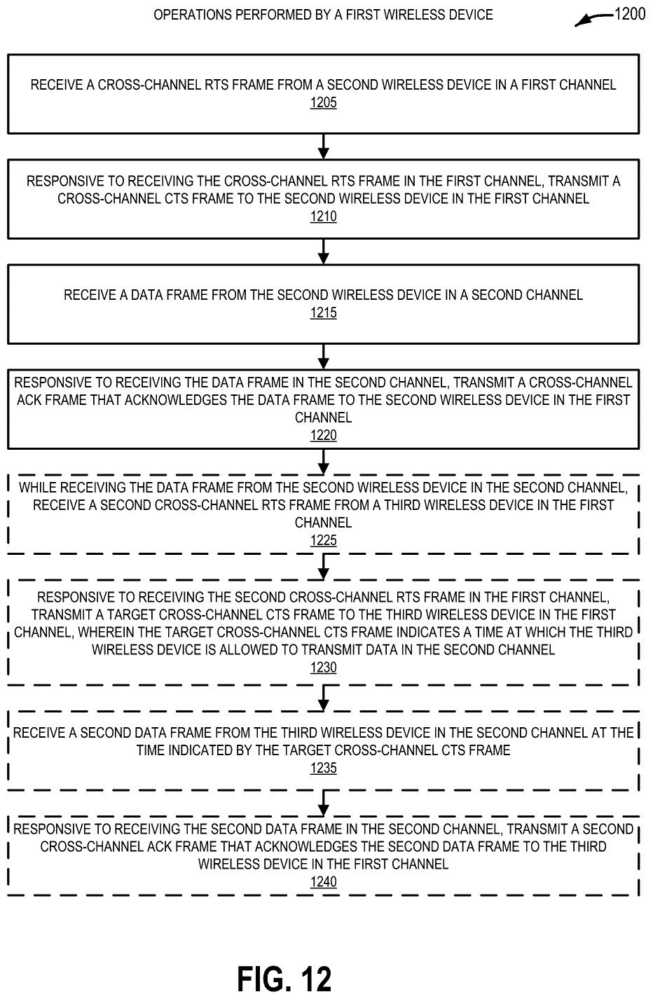

Turning now to FIG. 12, a method 1200 will be described for performing multi-channel operations, in accordance with an example embodiment. The method 1200 may be performed by one or more devices described herein. For example, the method 1200 may be performed by a first wireless device in a wireless network (e.g., STA2 shown in FIG. 8).

At operation 1205, the first wireless device receives a cross-channel RTS frame (e.g., RTS-mm frame) from a second wireless device in a first channel.

At operation 1210, responsive to receiving the cross-channel RTS frame in the first channel, the first wireless device transmits a cross-channel CTS frame (e.g., CTS-mm frame) to the second wireless device in the first channel.

At operation 1215, the first wireless device receives a data frame from the second wireless device in a second channel.

At operation 1220, responsive to receiving the data frame in the second channel, the first wireless device transmits a cross-channel ACK frame (e.g., ACK-mm frame) that acknowledges the data frame to the second wireless device in the first channel.

In an embodiment, the cross-channel RTS frame, the cross-channel CTS frame, and the cross-channel ACK frame are treated by legacy wireless devices as legacy control frames for the first channel and treated by non-legacy wireless devices as cross-channel control frames for the second channel.

In an embodiment, at operation 1225, while receiving the data frame from the second wireless device in the second channel, the first wireless device receives a second cross-channel RTS frame (e.g., RTS-mm frame) from a third wireless device in the first channel.

In an embodiment, at operation 1230, responsive to receiving the second cross-channel RTS frame in the first channel, the first wireless device transmits a target cross-channel CTS frame (e.g., T-CTS-mm frame) to the third wireless device in the first channel, wherein the target cross-channel CTS frame indicates a time at which the third wireless device is allowed to transmit data in the second channel.

In an embodiment, at operation 1235, the first wireless device receives a second data frame from the third wireless device in the second channel at the time indicated by the target cross-channel CTS frame.

In an embodiment, at operation 1240, responsive to receiving the second data frame in the second channel, the first wireless device transmits a second cross-channel ACK frame (e.g., ACK-mm frame) that acknowledges the second data frame to the third wireless device in the first channel.

In an embodiment, the first channel is a sub-7 GHz channel and the second channel is a mmWave channel.

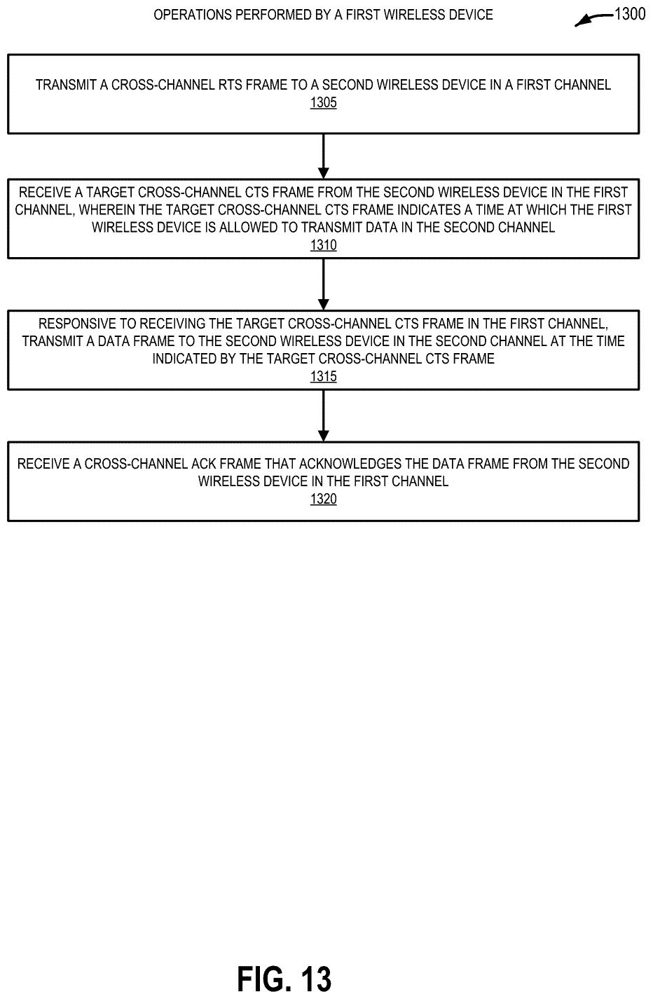

Turning now to FIG. 13, a method 1300 will be described for performing multi-channel operations, in accordance with an example embodiment. The method 1300 may be performed by one or more devices described herein. For example, the method 1300 may be performed by a first wireless device in a wireless network (e.g., STA3 shown in FIG. 8).

At operation 1305, the first wireless device transmits a cross-channel RTS frame (e.g., RTS-mm frame 820) to a second wireless device in a first channel.

At operation 1310, the first wireless device receives a target cross-channel CTS frame (e.g., T-CTS-mm frame) from the second wireless device in the first channel, wherein the target cross-channel CTS frame indicates a time at which the first wireless device is allowed to transmit data in the second channel.

At operation 1315, responsive to receiving the target cross-channel CTS frame in the first channel, the first wireless device transmits a data frame to the second wireless device in the second channel at the time indicated by the target cross-channel CTS frame.

At operation 1320, the first wireless device receives a cross-channel ACK frame (e.g., ACK-mm frame) that acknowledges the data frame from the second wireless device in the first channel.

In an embodiment, the first channel is a sub-7 GHz channel and the second channel is a mmWave channel.

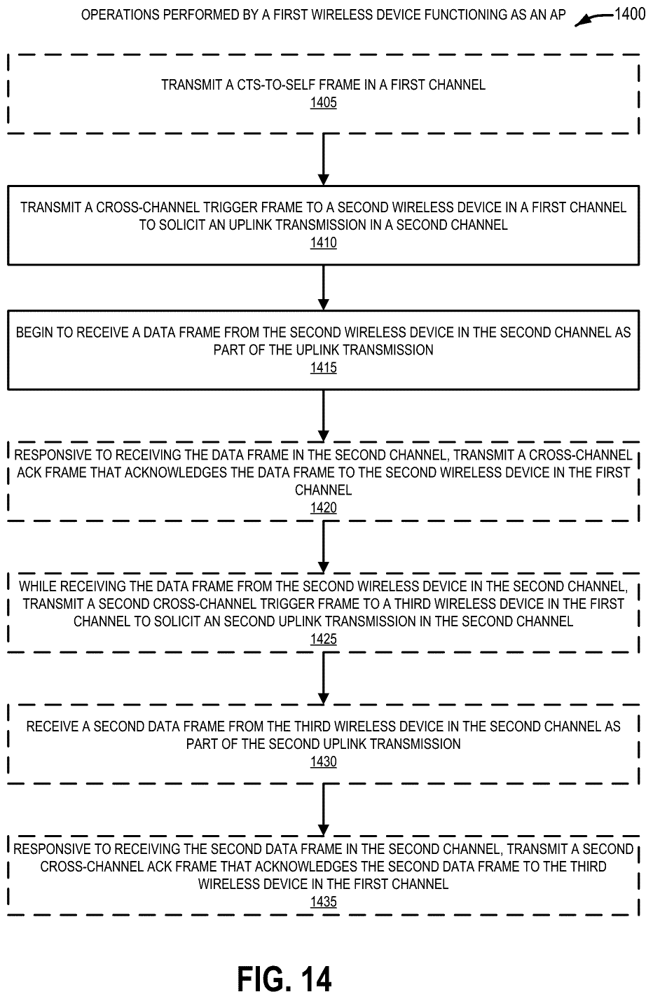

Turning now to FIG. 14, a method 1400 will be described for performing multi-channel operations, in accordance with an example embodiment. The method 1400 may be performed by one or more devices described herein. For example, the method 1400 may be performed by a first wireless device functioning as an AP in a wireless network (e.g., AP shown in FIG. 9).

In an embodiment, at operation 1405, the first wireless device transmits a CTS-to-self frame in a first channel (e.g., to set a NAV from the end of the CTS-to-self frame to the end of an upcoming/expected cross-channel ACK frame (which is transmitted by the first wireless device at operation 1420)).

At operation 1410, the first wireless device transmits a cross-channel trigger frame (e.g., trigger-mm frame) to a second wireless device in a first channel to solicit an uplink transmission in a second channel.

At operation 1415, the first wireless device begins to receive a data frame from the second wireless device in the second channel as part of the uplink transmission.

In an embodiment, at operation 1420, responsive to receiving the data frame in the second channel, the first wireless device transmits a cross-channel ACK frame (e.g., ACK-mm frame) that acknowledges the data frame to the second wireless device in the first channel.

In an embodiment, the cross-channel trigger frame and the cross-channel ACK frame are treated by legacy wireless devices as legacy control frames for the first channel and treated by non-legacy wireless devices as cross-channel control frames for the second channel.

In an embodiment, at operation 1425, while receiving the data frame from the second wireless device in the second channel, the first wireless device transmits a second cross-channel trigger frame to a third wireless device in the first channel to solicit a second uplink transmission in the second channel.

In an embodiment, at operation 1430, the first wireless device receives a second data frame from the third wireless device in the second channel as part of the second uplink transmission.

In an embodiment, at operation 1435, responsive to receiving the second data frame in the second channel, the first wireless device transmits a second cross-channel ACK frame that acknowledges the second data frame to the third wireless device in the first channel.

In an embodiment, the first channel is a sub-7 GHZ channel and the second channel is a mmWave channel.

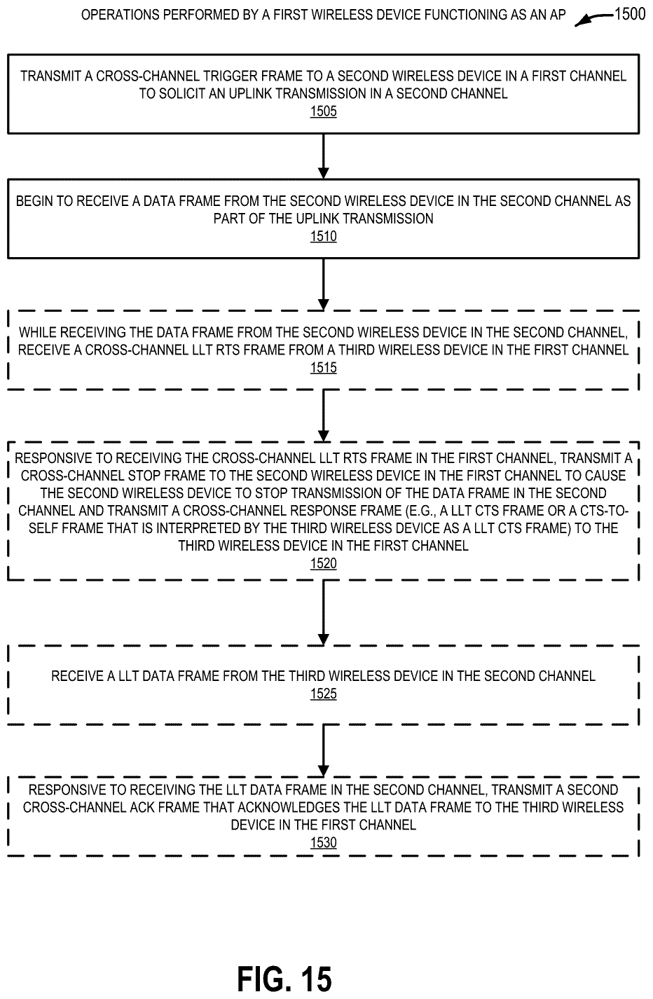

Turning now to FIG. 15, a method 1500 will be described for performing multi-channel operations, in accordance with an example embodiment. The method 1500 may be performed by one or more devices described herein. For example, the method 1500 may be performed by a first wireless device functioning as an AP in a wireless network (e.g., AP shown in FIG. 10). The operations of method 1500 may be performed in a scenario where the AP receives a cross-channel LLT RTS frame.

Although not shown in the diagram, in an embodiment, the first wireless device transmits a CTS-to-self frame in a first channel (e.g., to set a NAV from the end of the CTS-to-self frame to the end of an upcoming/expected cross-channel ACK frame (which corresponds to the data frame that the first wireless device begins to receive at operation 1510 but which is not transmitted in this example because the transmission of the data frame is stopped)).

At operation 1505, the first wireless device transmits a cross-channel trigger frame (e.g., trigger-mm frame) to a second wireless device in a first channel to solicit an uplink transmission in a second channel.

At operation 1510, the first wireless device begins to receive a data frame from the second wireless device in the second channel as part of the uplink transmission.

In an embodiment, at operation 1515, while receiving the data frame from the second wireless device in the second channel, the first wireless device receives a cross-channel LLT RTS frame (e.g., LLT-RTS-mm frame) from a third wireless device in the first channel.

In an embodiment, at operation 1520, responsive to receiving the cross-channel LLT RTS frame in the first channel, the first wireless device transmits a cross-channel stop frame (e.g., stop-mm frame) to the second wireless device in the first channel to cause the second wireless device to stop transmission of the data frame in the second channel and the first wireless device transmits a cross-channel response frame to the third wireless device in the first channel. In an embodiment, the cross-channel response frame is a cross-channel LLT CTS frame (e.g., LLT-CTS-mm frame). In such an embodiment, the first wireless device may transmit a CTS-to-self frame in the first channel before transmitting the cross-channel response frame to the third wireless device in the first channel (e.g., to set NAV from the end of the CTS-to-self frame to the end of an upcoming/expected cross-channel ACK frame (which is transmitted by the first wireless device at operation 1530)). In an embodiment, the cross-channel response frame is a CTS-to-self frame, wherein the third wireless device interprets the CTS-to-self frame as a cross-channel LLT CTS frame.

In an embodiment, at operation 1525, the first wireless device receives a LLT data frame (that includes low latency data) from the third wireless device in the second channel.

In an embodiment, at operation 1530, responsive to receiving the LLT data frame in the second channel, the first wireless device transmits a second cross-channel ACK frame that acknowledges the LLT data frame to the third wireless device in the first channel.

In an embodiment, the first channel is a sub-7 GHz channel and the second channel is a mmWave channel.

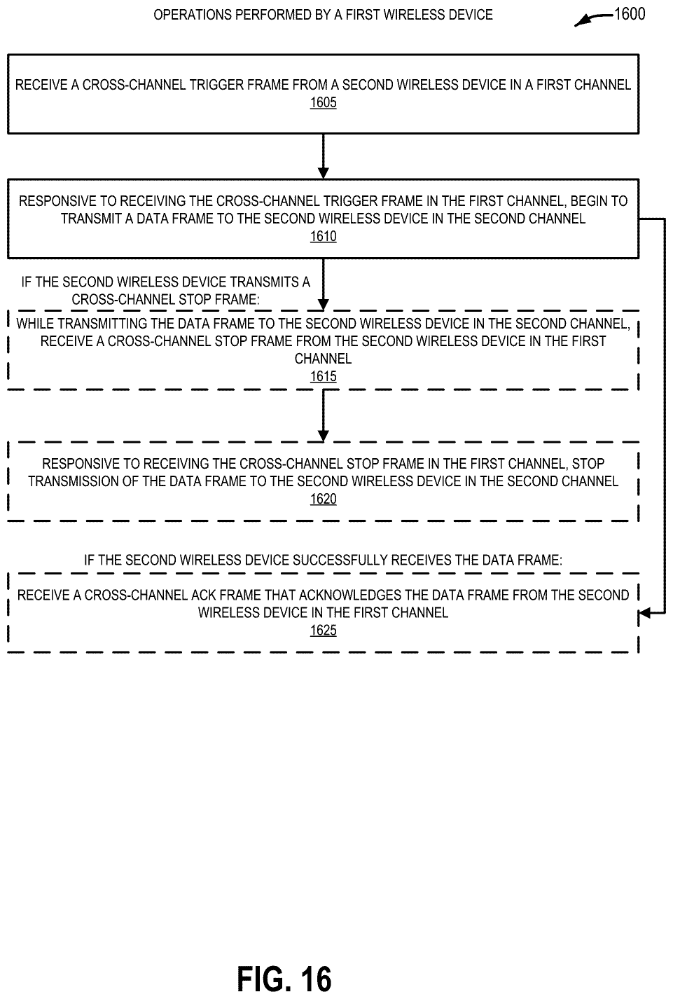

Turning now to FIG. 16, a method 1600 will be described for performing multi-channel operations, in accordance with an example embodiment. The method 1600 may be performed by one or more devices described herein. For example, the method 1600 may be performed by a first wireless device in a wireless network (e.g., STA1 shown in FIG. 10).

At operation 1605, the first wireless device receives a cross-channel trigger frame (e.g., trigger-mm frame) from a second wireless device in a first channel.

At operation 1610, responsive to receiving the cross-channel trigger frame in the first channel, the first wireless device begins to transmit a data frame to the second wireless device in the second channel.

The second wireless device may transmit a cross-channel stop frame (e.g., stop-mm frame) to the first wireless device if the second wireless device receives a cross-channel LLT RTS frame (e.g., LLT-RTS-mm frame) from another wireless device. In an embodiment, at operation 1615, while transmitting the data frame to the second wireless device in the second channel, the first wireless device receives a cross-channel stop frame from the second wireless device in the first channel.

In an embodiment, at operation 1620, responsive to receiving the cross-channel stop frame in the first channel, the first wireless device stops transmission of the data frame to the second wireless device in the second channel.

If the second wireless device successfully receives the data frame, the second wireless device may transmit a cross-channel ACK frame (e.g., ACK-mm frame) that acknowledges the data frame to the first wireless device. Thus, in an embodiment, at operation 1625, the first wireless device receives a cross-channel ACK frame that acknowledges the data frame from the second wireless device in the first channel.

In an embodiment, the first channel is a sub-7 GHz channel and the second channel is a mmWave channel.

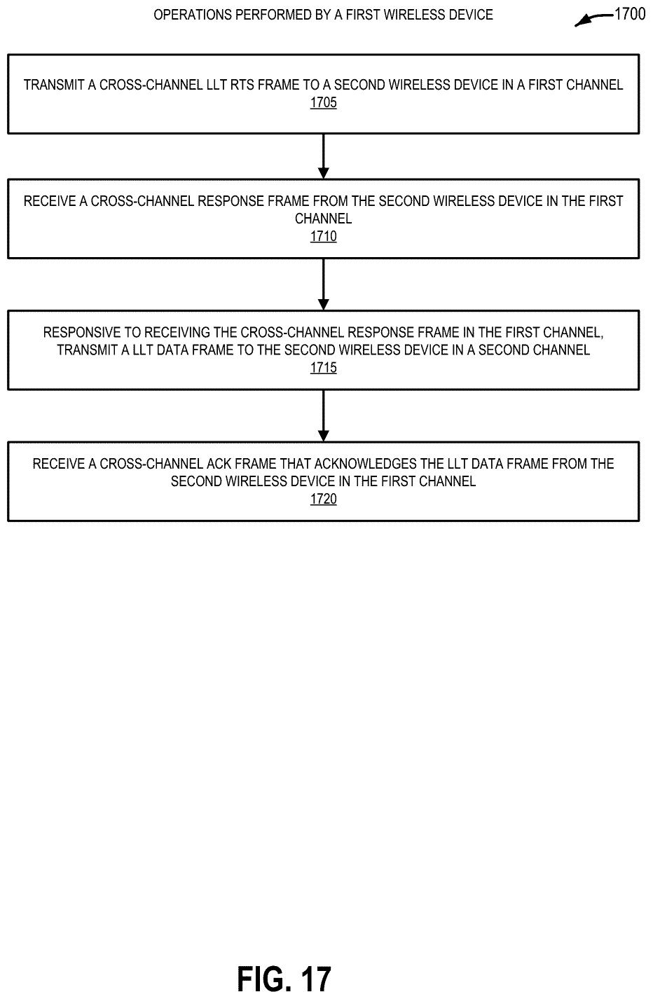

Turning now to FIG. 17, a method 1700 will be described for performing multi-channel operations, in accordance with an example embodiment. The method 1700 may be performed by one or more devices described herein. For example, the method 1700 may be performed by a first wireless device in a wireless network (e.g., STA2 shown in FIG. 10).

At operation 1705, the first wireless device transmits a cross-channel LLT RTS frame (e.g., LLT-RTS-mm frame) to a second wireless device in a first channel.

At operation 1710, the first wireless device receives a cross-channel response frame from the second wireless device in the first channel. In an embodiment, the cross-channel response frame is a cross-channel LLT CTS frame (e.g., LLT-CTS-mm frame). In an embodiment, the cross-channel response frame is a CTS-to-self frame, wherein the first wireless device interprets the CTS-to-self frame as a cross-channel LLT CTS frame.

At operation 1715, responsive to receiving the cross-channel response frame in the first channel, the first wireless device transmits a LLT data frame (that includes low latency data) to the second wireless device in a second channel.

At operation 1720, the first wireless device receives a cross-channel ACK frame (e.g., ACK-mm frame) that acknowledges the LLT data frame from the second wireless device in the first channel.

In an embodiment, the first channel is a sub-7 GHz channel and the second channel is a mmWave channel.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method performed by a first wireless device in a wireless network to perform multi-channel operations, the method comprising:
transmitting a cross-channel request-to-send (RTS) frame to a second wireless device in a first channel;
receiving a cross-channel clear-to-send (CTS) frame from the second wireless device in the first channel;
responsive to receiving the cross-channel CTS frame in the first channel, transmitting a data frame to the second wireless device in a second channel; and
receiving a cross-channel acknowledgement (ACK) frame that acknowledges the data frame from the second wireless device in the first channel.

2. The method of claim 1, wherein the first channel is a sub-7 Gigahertz (GHz) channel and the second channel is a millimeter wave (mmWave) channel.

3. The method of claim 1, further comprising:
transmitting a CTS-to-self frame in the first channel before transmitting the cross-channel RTS frame to the second wireless device in the first channel.

4. The method of claim 1, wherein the cross-channel RTS frame, the cross-channel CTS frame, and the cross-channel ACK frame are treated by legacy wireless devices as legacy control frames for the first channel and treated by non-legacy wireless devices as cross-channel control frames for the second channel.

5. A method performed by a first wireless device in a wireless network to perform multi-channel operations, the method comprising:
receiving a cross-channel request-to-send (RTS) frame from a second wireless device in a first channel;
responsive to receiving the cross-channel RTS frame in the first channel, transmitting a cross-channel clear-to-send (CTS) to the second wireless device in the first channel;
receiving a data frame from the second wireless device in a second channel; and
responsive to receiving the data frame in the second channel, transmitting a cross-channel acknowledgement (ACK) frame that acknowledges the data frame to the second wireless device in the first channel.

6. The method of claim 5, wherein the first channel is a sub-7 Gigahertz (GHz) channel and the second channel is a millimeter wave (mmWave) channel.

7. The method of claim 5, further comprising:
while receiving the data frame from the second wireless device in the second channel, receiving a second cross-channel RTS frame from a third wireless device in the first channel;
responsive to receiving the second cross-channel RTS frame in the first channel, transmitting a target cross-channel CTS frame to the third wireless device in the first channel, wherein the target cross-channel CTS frame indicates a time at which the third wireless device is allowed to transmit data in the second channel;
receiving a second data frame from the third wireless device in the second channel at the time indicated by the target cross-channel CTS frame; and
responsive to receiving the second data frame in the second channel, transmitting a second cross-channel ACK frame that acknowledges the second data frame to the third wireless device in the first channel.

8. A method performed by a first wireless device in a wireless network to perform multi-channel operations, the method comprising:
transmitting a cross-channel request-to-send (RTS) frame to a second wireless device in a first channel;
receiving a target cross-channel CTS frame from the second wireless device in the first channel, wherein the target cross-channel CTS frame indicates a time at which the first wireless device is allowed to transmit data in the second channel;
responsive to receiving the target cross-channel CTS frame in the first channel, transmitting a data frame to the second wireless device in the second channel at the time indicated by the target cross-channel CTS frame; and
receiving a cross-channel acknowledgement (ACK) frame that acknowledges the data frame from the second wireless device in the first channel.

9. The method of claim 8, wherein the first channel is a sub-7 Gigahertz (GHz) channel and the second channel is a millimeter wave (mmWave) channel.

10. A method performed by a first wireless device functioning as an access point (AP) in a wireless network to perform multi-channel operations, the method comprising:
transmitting a cross-channel trigger frame to a second wireless device in a first channel to solicit an uplink transmission in a second channel; and
beginning to receive a data frame from the second wireless device in the second channel as part of the uplink transmission.

11. The method of claim 10, wherein the first channel is a sub-7 Gigahertz (GHz) channel and the second channel is a millimeter wave (mmWave) channel.

12. The method of claim 10, further comprising:
responsive to receiving the data frame in the second channel, transmitting a cross-channel acknowledgement (ACK) frame that acknowledges the data frame to the second wireless device in the first channel.

13. The method of claim 12, wherein the cross-channel trigger frame and the cross-channel ACK frame are treated by legacy wireless devices as legacy control frames for the first channel and treated by non-legacy wireless devices as cross-channel control frames for the second channel.

14. The method of claim 10, further comprising:
transmitting a CTS-to-self frame in the first channel before transmitting the cross-channel trigger frame to the second wireless device in the first channel.

15. The method of claim 10, further comprising:
while receiving the data frame from the second wireless device in the second channel, transmitting a second cross-channel trigger frame to a third wireless device in the first channel to solicit a second uplink transmission in the second channel;
receiving a second data frame from the third wireless device in the second channel as part of the second uplink transmission; and
responsive to receiving the second data frame in the second channel, transmitting a second cross-channel ACK frame that acknowledges the second data frame to the third wireless device in the first channel.

16. The method of claim 10, further comprising:
while receiving the data frame from the second wireless device in the second channel, receiving a cross-channel low latency transmission (LLT) RTS frame from a third wireless device in the first channel;
responsive to receiving the cross-channel LLT RTS frame in the first channel, transmitting a cross-channel stop frame to the second wireless device in the first channel to cause the second wireless device to stop transmission of the data frame in the second channel and transmitting a cross-channel response frame to the third wireless device in the first channel;
receiving a LLT data frame from the third wireless device in the second channel; and
responsive to receiving the LLT data frame in the second channel, transmitting a second cross-channel ACK frame that acknowledges the LLT data frame to the third wireless device in the first channel.

17. The method of claim 16, wherein the cross-channel response frame is a cross-channel LLT CTS frame.

18. The method of claim 17, further comprising:
transmitting a CTS-to-self frame in the first channel before transmitting the cross-channel response frame to the third wireless device in the first channel.

19. The method of claim 16, wherein the cross-channel response frame is a CTS-to-self frame, wherein the third wireless device interprets the CTS-to-self frame as a cross-channel LLT CTS frame.

20.-29. (canceled)
